(19) United States
(12) Patent Application Publication
(10) Pub. No.: US 2022/0305845 A1
(43) Pub. Date: Sep. 29, 2022

(54) WHEEL ASSEMBLY WITH COVER RETENTION SYSTEM

(71) Applicant: SUPERIOR INDUSTRIES INTERNATIONAL, INC., SOUTHFIELD, MI (US)

(72) Inventor: HENRY CLAY CHENAULT, III, Fayetteville, AR (US)

(73) Assignee: SUPERIOR INDUSTRIES INTERNATIONAL, INC., SOUTHFIELD, MI (US)

(21) Appl. No.: 17/608,414

(22) PCT Filed: May 8, 2020
(86) PCT No.: PCT/US2020/031996

§ 371 Date: Nov. 2, 2021

Related U.S. Application Data
(60) Provisional application No. 62/844,842, filed on May 8, 2019.

(51) Int. Cl. B60B 7/06; B60B 7/04; B60B 7/08

(52) U.S. Cl. CPC B60B 7/063; B60B 7/04; B60B 7/08; B60B 2900/541; B60B 2900/572

(57) ABSTRACT

A wheel assembly includes a rim element having an annular configuration defining an axis, and a spider defining a central element circumscribing the axis with a plurality of spokes extending radially outwardly between the central element and the rim element. Adjacent of the spokes define an opening therebetween and are interconnected by a web circumscribing the opening. A cover defines a connector that is disposed over the spider concealing a portion of the spider and opening circumscribed by the web. The web defines a receptor configured to engage the connector thereby retaining the cover to the spider.

### PRIOR APPLICATIONS

The present application claims priority to International Patent Application No. PCT/US2020/031996, filed on May 8, 2020 which claims priority to U.S. Provisional Patent Application No. 62/844,842, filed on May 8, 2019, the contents of which are incorporated herein by reference.

### TECHNICAL FIELD

The present invention relates generally toward a road wheel for a vehicle. More specifically, the present invention relates to an improved retention system for a wheel cover providing decorative and performance enhancements.

### BACKGROUND

Alloy wheels have been in use for many years. The light weight and desirable appearance of alloy wheels has led in ever increasing market share in the vehicle wheel market. However, improvements to both appearance and performance have been driven by the competitive nature of the wheel market and the desire to reduce mass and improve fuel efficiency the vehicle on which the alloy wheel is placed.

One example of optimized wheel configuration is the Alulite™ wheel offered by Superior Industries International, Inc. that is disclosed in U.S. Pat. Nos. 9,815,323 and 10,300,738, the contents both of which are incorporated herein by reference. These patents disclose substantial wheel mass reductions by optimizing structural elements of the wheel. The lowest mass wheel configuration does not necessarily provide desirable esthetics but provides a previously thought unachievable low mass wheel.

One concept for taking advantage of both low mass wheel performance while providing distinguishing appearance is to attach a composite cover to a spider or face of the wheel. In this manner, the spider may be designed specifically for low mass while the cover provides a desirable appearance. While still being investigated, it is also believed that a strategically placed cover may also provide improved aerodynamics to the wheel whiles still enabling the reduction of mass.

Poor retention of the cover to a wheel assembly has restricted the use of this type of wheel assembly. Presently, covers are primarily secured to cast alloy wheels with screws, bolts, or adhesives. These attachment methods are known to be uneconomical or do not provide sufficient durability. In addition, the use of screws or bolts can lead to galvanic corrosion if the paint coating on the alloy wheel has been pierced during assembly and the wrong screw materials are selected. Attempts at using snapping features have also been inadequate due to the proximity of the snap to a vehicle brake. In most cases, insufficient space is available between a vehicle brake and a snap to provide sufficient performance characteristics to the wheel assembly. Therefore, it would be desirable to develop a wheel assembly having an improved attachment feature between the cover and the wheel.

### SUMMARY

A wheel assembly includes a rim element and a spider presenting a face. The rim element includes an annular configuration defining an axis. The spider defines a central element circumscribing the axis. A plurality of spokes extends radially outwardly between the central element and the rim element. An opening is defined between adjacent spokes, which present a continuous interconnected by a web circumscribing the opening. A cover defines a connector or snap and is placed over the spider concealing at least a portion of the spider or opening defined between adjacent spokes. The web defines a receptor configured to engage the connector defined by the cover for retaining the cover to the spider.

The receptor of the present invention, in various embodiments, includes a plurality of cavities, slots, pockets, or one continuous groove disposed in or close to the web on a rear surface of the spider. The receptor is optimized to reduce space required of a snapping engagement with a cover. In one embodiment, the receptor is a spoke receptor including a boss that is defined in an “as-cast” configuration with structural elements defined by the spider. The boss is milled to present a high precision surface without modifying the structural integrity of the as-cast configuration of the spider. This concept allows the optimization of the receptor location and configuration along with the structural elements defined by the spider. In another embodiment, the receptor is a rim receptor milled into the web at the wheel rim. Such optimization provides the lowest possible mass to a wheel while taking advantage of an optimized cover providing efficient and low-cost engagement to the wheel.

### BRIEF DESCRIPTION OF THE DRAWINGS

Other advantages of the present invention will be readily appreciated as the same becomes better understood by reference to the following detailed description when considered in connection with the accompanied drawings, wherein:

FIG. 1 shows a perspective view of a vehicle wheel;

FIG. 2 shows a partial first embodiment of the wheel assembly of the present invention;

FIG. 3 shows a partial perspective view of a cover being affixed to a wheel web;

FIG. 4 shows an exploded view, sectional of the wheel assembly through line 5-5 of FIG. 2;

FIG. 5 shows an assembled, sectional view of the wheel assembly through line 5-5 of FIG. 2;

FIG. 6 shows an exploded view, sectional of the wheel assembly through line 7-7 of FIG. 2;

FIG. 7 shows an assembled, sectional view of the wheel assembly through line 7-7 of FIG. 2;

FIG. 8 shows a partial plan view of connectors engaging alternative receptors defined by a web;

FIG. 9 shows a sectional view of a rim boss through line 9-9 of FIG. 8; and

FIG. 10 shows a sectional view of a spoke boss through line 10-10 of FIG. 8.

### DETAILED DESCRIPTION

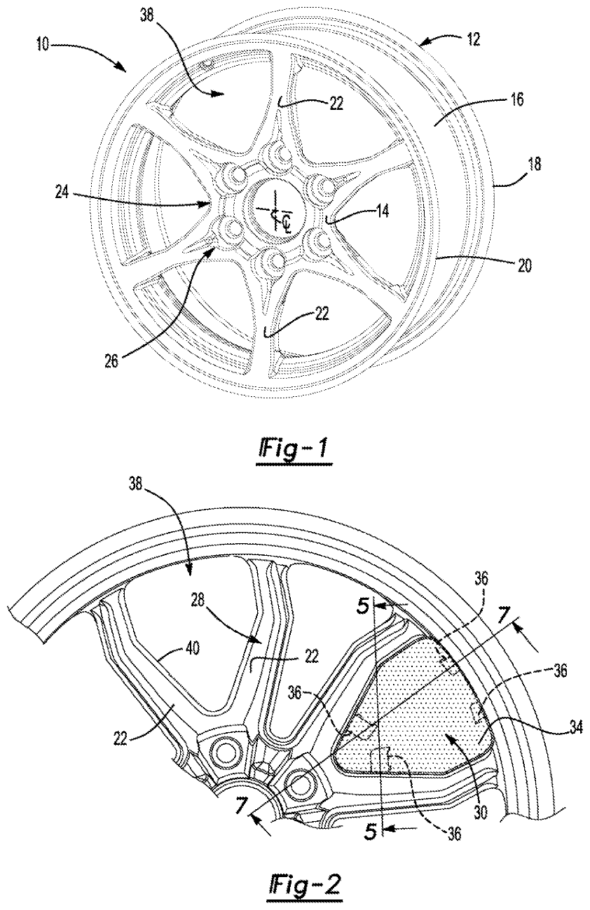

Referring to FIG. 1, a wheel of the present invention is generally shown at 10. The wheel includes a rim element 12 that defines an axis a. A central element 14 extends radially outwardly between the axis and the rim element 12. The rim element 12 defines a drop surface (or annular wall) 16 that extends between a distal bead 18 and a proximal bead 20 at a location that is disposed radially inwardly toward the axis a from the two beads 18, 20. It should be understood by those of ordinary skill in the art that the proximal bead 20 is located outboard of a motor vehicle (not shown) and the distal bead 18 is located inboard of the motor vehicle. Furthermore, the drop surface 16 is defined as a cylindrical surface circumscribing the axis a in a known manner. Spokes 22 extend outwardly from the central element 14 to the distal bead 20 together forming a wheel spider 24. The wheel spider 24 includes a front face 26 and a rear surface 28 (FIG. 2).

FIG. 2 shows a rear view of the wheel 10, now an assembly including an installed cover 30. This section shows each spoke 22 increasing in thickness as it extends toward the axis a. Additionally, the rear surface 28 of the spider 24, in one embodiment, is substantially an as-cast configuration as described in detail in U.S. Pat. Nos. 9,815,323 and 10,300,738, the contents of which are included herein by reference. Further, in this embodiment, both the front face 26 and the rear surface 28 of the spider 24 are contemplated to be “as cast”, providing ease of production thereby taking advantage of decorative features provided by the cover 30 without the cost associated with milling or turning. As used herein, “as cast” includes spokes having only flashing resulting from die parting lines being machined and the cast configuration of the spokes 22 is left unaltered including structural features defined in the spokes. Further discussion of the structural elements is not included in this application for brevity.

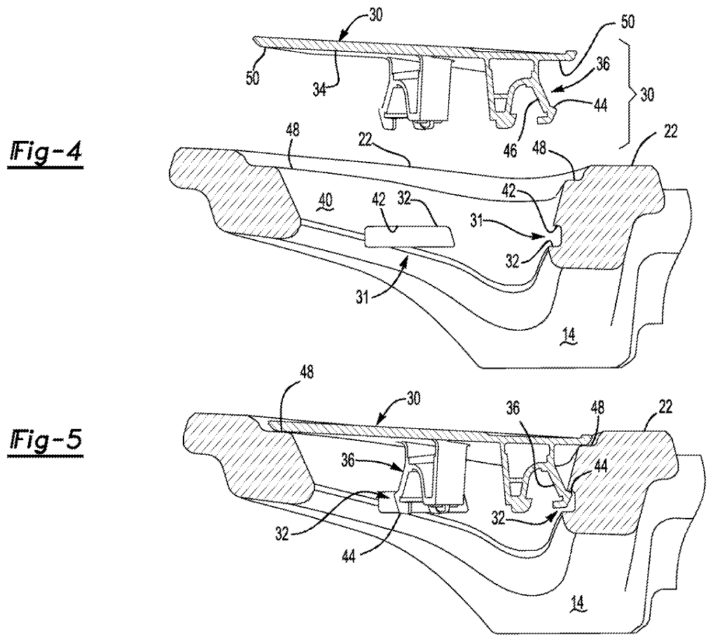

The as-cast surfaces provide ease of manufacturing by substantially eliminating turning or machining the front surface 26 and rear surface 28 of the wheel, particularly when including decorative or aerodynamic cover 30. Any machining of the front surface 26 is reserved for providing desired appearance such as, for example, a bright shiny surface that will be exposed. Machining to provide structural or substantive geometric modifications is virtually eliminated. However, it should be understood that the amount of machining performed on the wheel 10 is inconsequential to the invention of the present application, other than removing flashing known to occur at die parting lines and machining receptors 31 (FIG. 4) as will be explained further herein below.

Referring again to FIG. 2, the rear view of the wheel assembly 10 is shown. A rear wall 34 of the cover 30 is shown including a plurality of snaps or connectors 36 adjacent to the web 40 a web circumscribing each opening 38 in the spider 24. The web 40 presents a continuous surface extending along the adjacent spokes 22 and to the proximal bead 20 and the central portion 14. In one embodiment, the receptors 31 are located at the web 42 and are configured to engage the snaps 36 disposed upon the rear wall 34 of the cover 30. As such, each receptor 31 includes an engagement surface 42 the presents a surface to interlock with the snap 36 as will be explained further herein below.

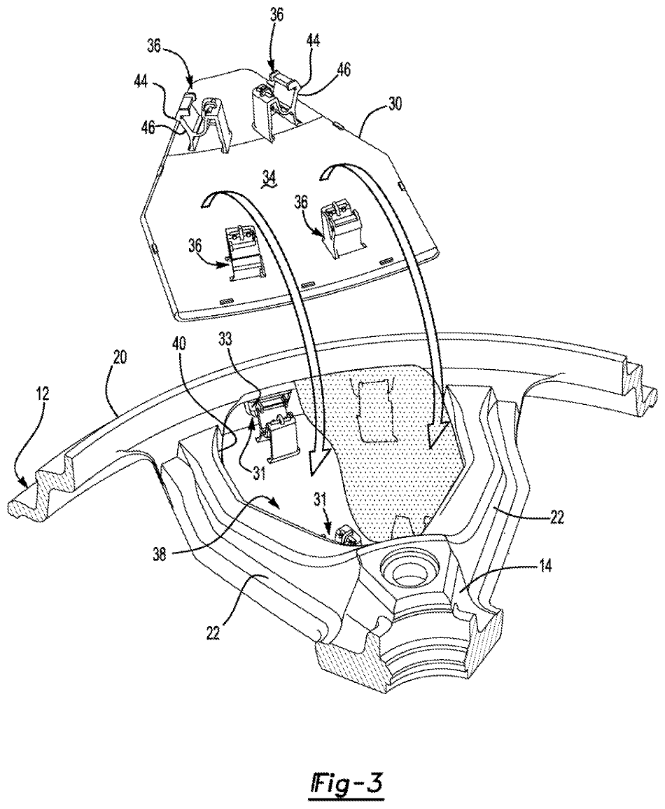

As best represented in FIGS. 2 and 3, each spoke 22 includes a spoke receptor 32 disposed at the web 40. Additionally, a rim receptor 33 is disposed at the web 40 proximate the rim element 12. Therefore, opposing receptors 32 are spaced around the wheel opening 38 at the web 40 where retention forces are opposing providing enhanced retention of the cover 30 to the wheel 10. In a first embodiment, the spoke receptor 32 is defined as one or a plurality of a slots or cavities machined into the web 40. Further, the rim receptor 33 is also defined as one or a plurality of a slots or cavities machined into the web 40. In one embodiment, it is desirable to machine or mill the receptors 32, 33 at the same time flashing is machined or milled at a die party line as is known to those of skill in the art providing efficient manufacturing processes.

As set forth above and shown in FIGS. 4 and 5, the cover 30 defines a rear wall 34. The plurality of snaps 36 or connectors are spaced around the rear wall 34 as is best represented in FIG. 3. Each snap 36 defines a hook 44 disposed at a distal end of a snap arm 46 for engaging the engagement surface 42 defined by the receptors 31, 32, 33. Each snap arm 46 flexes while mating the cover 30 to the wheel 10 as the hook 44 interfaces with the web 40. When the hook 44 reaches the receptor 31, 32, 33 to which it is aligned, the snap arm 46 returns toward its original disposition causing the hook 44 to engage the engagement surface 42 of the receptor 31, 32, 33. When each of the plurality of hooks 44 has engaged the corresponding receptors 31, 32, 33, the cover 30 is retained onto the wheel 10 thereby constituting the wheel assembly. It should be understood that both forces in the axial direction and forces that are offset from the axis a are providing secure engagement of the cover 30 to the wheel 10.

In one embodiment best represented in FIG. 2, a plurality of covers 30 may be implemented on a single wheel, each individually covering a separate opening 38 defined by adjacent spokes 22. All or some of the openings 38 may be covered by individual covers 30. Alternatively, a single cover 30 may be secured over the entire spider 24. In this manner, the face of the cover 30 presents a contoured configuration completely covering all of the openings 38 and the spider 24. A variety of different configurations of the cover 30 either in plurality or singularly may take advantage of the unique interface between the snap 36 and the Receptor 32.

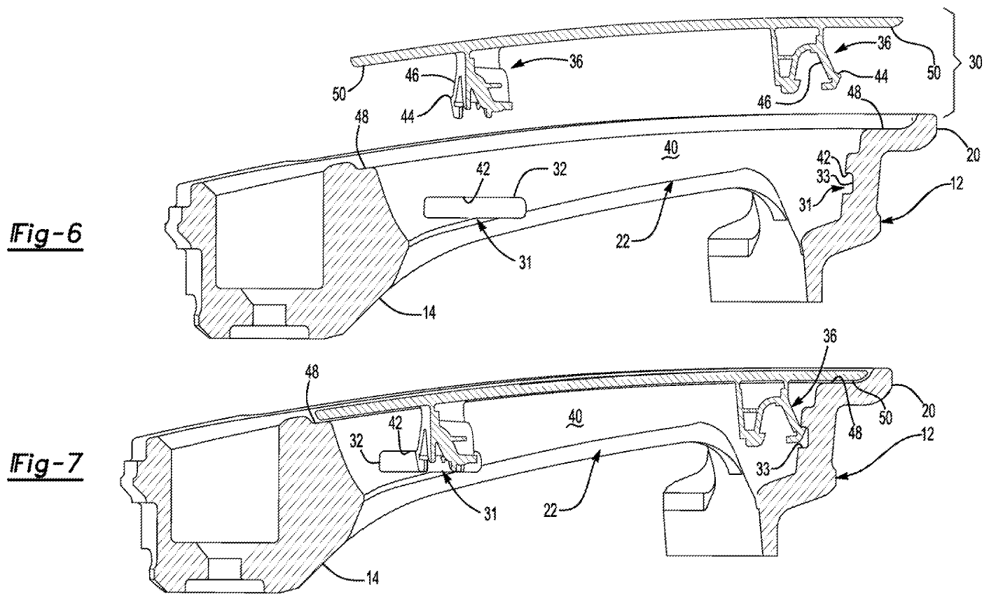

As best represented in FIGS. 6 and 7, the wheel presents an abutment 48 that circumscribed the opening 38 defined by the rim element 12, the central element 14 and the spokes 22. The abutment 48 receives a meeting lip 50 of the cover 30 when the cover 30 is engaged with the wheel 10 and retained by engagement of the snaps 36 with the receptor 32. The abutment 48 provides necessary retention force to the snaps 36 in the axial direction. Further, the receptors 32 are precision milled or machined at a precise distance from the abutment 48 to provide consistent and repeatable retention force in the axial direction when each hook 44 is in engagement with the engagement surface 42 of each receptor 32. Precision milling of the receptors 32 enable this high-quality engagement of the cover 30 to the wheel 10.

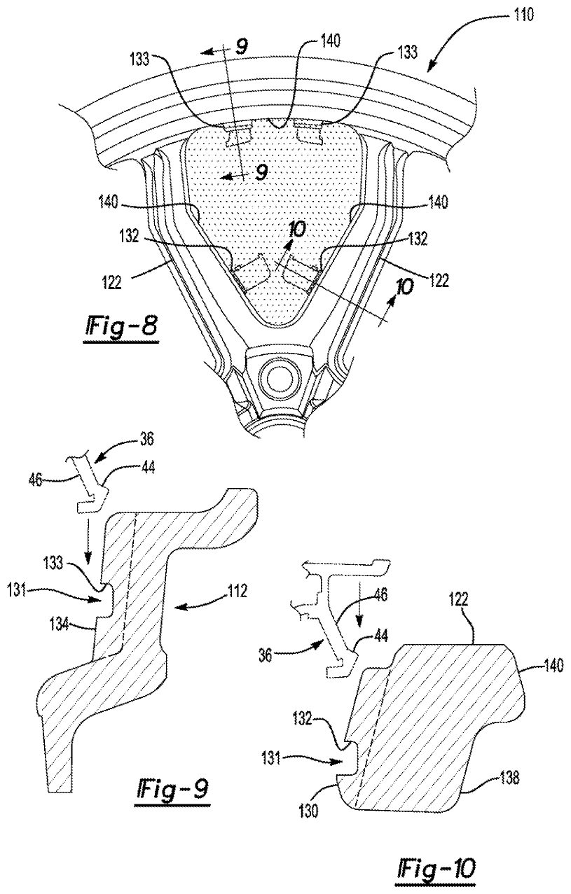

An alternative embodiment is shown in FIGS. 8 through 10. In this embodiment, an alternative receptor is shown at element number 131 in general. An alternative spoke receptor is shown at 132 and an alternative rim receptor is shown at 133. The alternative spoke receptor 132 is formed into a spoke boss 130 that is disposed on the alternate web 140 at the spoke 122. The spoke boss 130 is disposed in an as-cast configuration. Therefore, while forming the structural feature on the spokes 122 the boss is formed at the same time. In a similar manner, the rim receptor 133 is formed in a rim boss 134 that is disposed in the alternate web 140 at the rim element 12. The rim boss 134 is disposed in an as-cast configuration having the rim receptor 133 formed therein. In one embodiment, the alternate spoke receptor 132 and the alternate rim receptor 133 are machined into the rim boss 134 and the spoke boss 130, respectively.

As best represented in FIG. 10, the alternate spoke 122 includes the first leg 138 and a second leg 140. The structure of the first leg 138 and the second leg 140 provide structural integrity to the alternate spoke 122 providing a reduction in mass of the wheel 110. Therefore, when the spoke boss 130 is implemented, the structural feature defined by the first leg 138 and the second leg 140 do not require machining or any reduction in volume, which could reduce the structural integrity of the wheel 110.

The invention has been described in an illustrative manner, and it is to be understood that the terminology that has been used is intended to be in the nature of words of description rather than of limitation. Obviously, many modifications and variations of the present invention are possible in light of the above teachings. It is therefore to be understood that within the specification, the reference numerals are merely for convenience, and are not to be in any way limiting, and that the invention may be practiced otherwise than is specifically described. Therefore, the invention can be practiced otherwise than is specifically described within the scope of the intended claims.

What is claimed is:

1. A wheel assembly, comprising:
a rim element having an annular configuration defining an axis;
a spider defining a central element circumscribing said axis and defining a plurality of spokes extending radially outwardly between said central element and said rim element;
adjacent of said spokes defining an opening therebetween and being interconnected by a web circumscribing said opening;
a cover defining a connector and being disposed over said spider thereby concealing a portion of said spider; and
said web defining a receptor configured to engage said connector thereby retaining said cover to said spider.

2. The assembly set forth in claim 1, wherein spider defines a face and a rear portion with said receptor being disposed at said rear portion.

3. The assembly set forth in claim 2, wherein said receptor is defined as a groove defined by said web and disposed in said rim.

4. The assembly set forth in claim 2, wherein said receptor is defined by a boss disposed in said web of said spider.

5. The assembly set forth in claim 2, wherein said connector defines an engagement member for engaging said receptor thereby retaining said cover to said wheel.

6. The assembly set forth in claim 5, wherein said face defines an abutment for abutting said cover thereby providing a mating force to said engagement member.

7. The assembly set forth in claim 5, wherein said receptor defined by said spider includes an as-cast boss configuration.

8. The assembly set forth in claim 7, wherein said receptor includes a milled surface being substantially perpendicular to said axis of said wheel and said milled surface is engaged by said engagement member of said connector.

9. The assembly set forth in claim 1, wherein said receptor is defined by said web at a location disposed between adjacent of said spokes.

10. The assembly set forth in claim 1, wherein said receptor is disposed at a mating seam defined in said spider.

11. The assembly set forth in claim 1, wherein said receptor is disposed in said web at said wheel rim.
